(19) United States
(12) Patent Application Publication
(10) Pub. No.: US 2006/0088753 A1
(43) Pub. Date: Apr. 27, 2006

(54) Sealing frame for fuel cell stacks

(76) Inventors: Manfred Stefener, Munchen (DE); Christian Bohm, Siegertsbrunn (DE); Markus Huber, Grafing (DE); Volker Harbusch, Munchen (DE)

Correspondence Address: IP STRATEGIES, 12 1/2 WALL STREET, SUITE I, ASHEVILLE, NC, 28801, US

(21) Appl. No.: 10/503,286

(22) PCT Filed: Jan. 15, 2003
(86) PCT No.: PCT/EP03/00361

§ 371 Date: Dec. 28, 2005

(30) Foreign Application Priority Data
Jan. 31, 2002 (EP) 02002361.0

(51) Int. Cl. H01M 2/08; H01M 8/02

(52) U.S. Cl. 429/35; 429/38

(57) ABSTRACT

The invention relates to a sealing frame (50) for fuel cell stacks having an alternating arrangement of flow plates (10) and electrolytic facilities (20) and cathode and anode regions formed between the flow plates (10) and the electrolytic facilities (20), wherein the sealing frame (50) is formed such that it is suited for installation between the flow plates (10) and ensures the mutual sealing of the cathode regions and the anode regions,

### FIELD OF THE INVENTION

The invention relates to a sealing frame to be installed between the flow plates of a fuel cell stack having an alternating arrangement of flow plates and electrolytic facilities and cathode and anode regions formed between the flow plates and the electrolytic facilities. The sealing frame is formed such that it is suited for the installation between the flow plates and ensures the mutual sealing of the cathode regions and the anode regions.

### PRIOR ART

In technical science fuel cell stacks refer to stacked fuel cells connected with each other in a unipolar or bipolar manner. They are substantially constituted by an alternating arrangement of flow plates and electrolytic facilities.

The flow plates separate the individual fuel cells and serve the fluid guidance of fluids on the cathode side and the anode side required for the operation of the fuel cell stack and formed thereby. To this end, the two sides of each flow plate comprise regions with flow channels, which—in technical science—are generally called flow fields.

In the case of stacks constructed in a bipolar manner the flow plate is formed as a bipolar plate, whereof one side forms the flow regions on the side of the cathode while the other side forms the flow regions on the side of the anode.

The electrolytic facilities comprise the actual electrolyte, e.g. a polymer membrane, as well as the active regions provided at both sides of each electrolyte with catalyst facilities, gas diffusion layers, which cause the fluids to be supplied uniformly from the flow regions of the adjacent flow plates to the electrolytic facilities, and electrode facilities for the extraction of power. All these element are planar.

In the case of a membrane as electrolyte, the expression MEA (for “Membrane Electrode Assembly”) is frequently used for the electrolytic facility in technical science. Partially, several functions may be integrated in one facility. Thus, a layer is provided for the MEA units, which serves as electrode and as gas diffusion layer simultaneously.

The permeable electrolytic facilities worth mentioning only with respect to predetermined ions are responsible for the redox processes, which take place physically separated. According to the oxidizing or, respectively, reducing character of the partial reactions taking place on both sides of the electrolytic facilities the regions between the flow plates and the electrolytic facilities are called cathode and anode regions (or cathode and anode chambers).

An essential requirement for the operation of a fuel cell stack resides in that no mixing of fluids on the cathode's side and the anode's side occurs.

Therefore, the cathode and the anode regions have to be reliably and permanently sealed against each other during the fabrication of the stack.

In some known embodiments electrolytic facilities with approximately the same square measures of the flow plates are used, with the active region of the electrolytic facility being clearly smaller, however. For the purpose of sealing, seals are provided between the flow plates and the electrolytic facilities, which are to seal the peripheral areas of the contact surfaces of the flow plates and the electrolytic facilities towards the outside while sparing the active regions.

In other embodiments substantially the entire surface of the electrolytic facilities is used as active region. MEA facilities of this type are, in technical science, frequently called “flush cut MEA”. In accordance therewith the electrolytic facilities have a clearly smaller superficial extent than the flow plates. For sealing purposes, seals are attached to the electrolytic facilities so as to surround them peripherally, e.g. by welding or gluing of a polymer foil on it. These combinations of an electrolytic facility and a peripherally provided seal are, as a rule, prefabricated.

In all of these embodiments the seals are to prevent an undesired escape of fluids from the respective cathode or anode chambers on the sides thereof. For this purpose, they must be positioned with precision when the stacks are assembled, which, due to their small dimensional stability, requires utmost care and thus causes a considerable share in the fabrication.

However, even if impermeability is ensured at the beginning, leakages may occur in the course of time due to fatigue and/or flow behavior of the conventional sealing types.

Another cause for leakages resides in that the flow fields of the flow plates often comprise channels for the supply and the removal of fluids, which push through the lateral areas of the plates. By this, sealing material provided in these areas is compressed at different strengths during the assembly of the fuel cell stack, which may likewise entail leakages.

### DESCRIPTION OF THE INVENTION

The invention is based on the problem to eliminate the difficulties associated with the sealing of fuel cell stacks.

A particular aspect of the invention moreover resides in facilitating the assembly of a fuel cell stack.

These problems are overcome by the sealing frame according to the invention, which is defined in claim 1.

The sealing frame according to the invention is provided for the installation between the flow plates of a fuel cell stack and is formed such that it ensures the mutual sealing of the cathode regions and the anode regions of the stack.

According to an advantageous further development the outer dimensions of the sealing frame are adapted to those of the flow plates, while the inner dimensions, i.e. the dimensions of the frame's recess, are adapted to the active regions of the electrolytic facilities.

In contrast to a sealing material conventionally used for sealing purposes in view of fuel cell stacks, the sealing frame according to the invention is dimensionally stable and self-supporting, so that it can be handled more easily. Thus, the precision required for finishing the stack is achieved more easily as compared, for example, to a soft flexible sealing material. Neither the assembly of the stack nor the operation of the finished fuel cell facility result in significant changes in the shape and/or the dimensions of the frame. Therefore, the frame is, for example, suited to support a conventional sealing material and, in particular, can advantageously be used as base material for such seals so as to prevent dimensional changes of the seal.

The seals may be connected to the sealing frames prior to the actual assembly of the stack, so that said prefabricated dimensionally stable combinations can be used when the stack is assembled.

If suitable materials are used, the thickness of the sealing frame may be so small that its contribution to the total height of the stack does not matter as compared to the realization without the use of the frame.

In order to functionally influence the stack as little as possible, the inner dimensions of the frame are advantageously adapted to the outline of the active region of the electrolytic facility. The sealing frame, therefore, advantageously has substantially the same (i.e., if at all, slightly deviating) outer dimensions as the flow plates, and the recess has a dimension, whereof the dimensions substantially correspond to those of the active region of the electrolytic facility of the fuel cell stack.

According to a particularly preferred further development the sealing frame comprises a sealing material for sealing contact surfaces between flow plates and/or between a flow plate and an electrolytic facility.

With both the integral formation of the sealing frame and the seal, e.g. if the sealing frame is formed as a metallic seal, and with the aforementioned prefabricated combinations of the sealing frame with the seal attached thereon can the fabrication process of the fuel cell stack be clearly facilitated.

In the former case, also plastics materials and composite materials can be used instead of the metallic seals, which may be reinforced for fulfilling the stability requirements, if necessary. In the second case, the sealing frame can be coated with the sealing material on one or both sides, as required.

Also combinations of these two further developments may be advantageous, if, for example, a kind of sealing material has desired dimensional stability properties, while other kinds are better for producing permanent connections with contacting regions of the flow plate or the electrolytic facility.

According to a preferred further development the sealing frame according to the invention comprises recesses for mounting devices and/or facilities for the supply and removal of fluids. This results in a further facilitation of the assembly procedure, since the additional work associated with providing such recesses for necessary leadthroughs during or after the assembly of the stack is avoided.

In many cases electrolytic facilities are constituted by thin membranes, which likewise only have a small inherent stability. In such cases it may be an advantage to prefabricate combinations of sealing frames and electrolytic facilities connected with each other in a fluid-impermeable manner, which are likewise substantially easier to handle during the assembly of the stack than the electrolytic facility on its own. This further development comprises, of course, also prefabricated combinations of the sealing frame according to the invention with electrolytic facilities and seals peripherally surrounding the same.

According to another preferred further development the invention provides for prefabricated fluid-impermeable combinations of the flow pate and the sealing frame.

These combinations may be formed of one flow plate and one sealing frame. Alternatively, both sides of a flow plate may be provided with sealingly arranged sealing frames. In both cases the assembly process may clearly be facilitated during the assembly of the fuel cell stack.

The basic principles and further advantages of the invention become clear from the following description of the figures, wherein

FIG. 1 shows a schematic representation of a fuel cell stack;

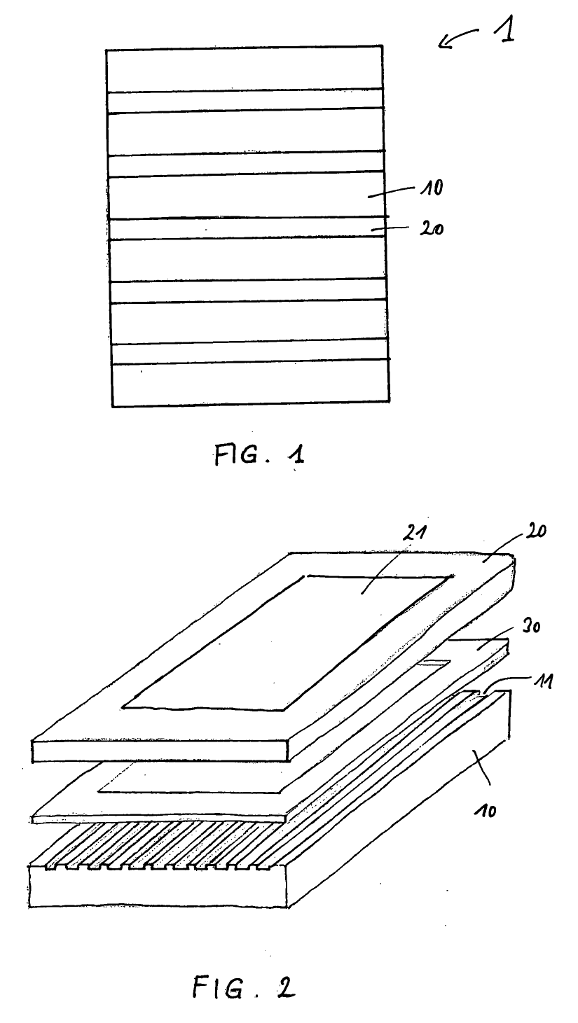

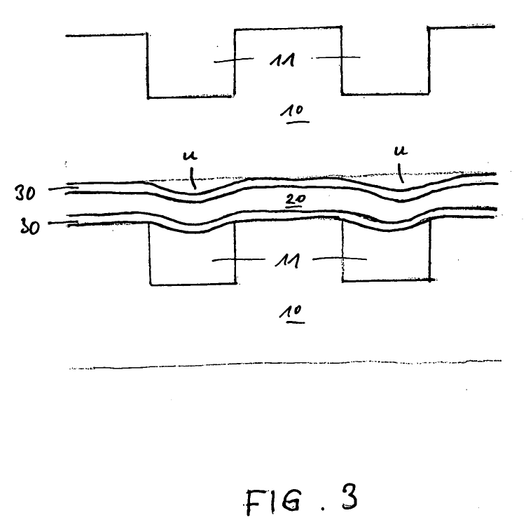

FIG. 2 shows a perspective explosive representation of an enlarged section of the fuel cell stack;

FIG. 3 shows a sectional view for illustrating a possible cause for leakages in conventional stacks;

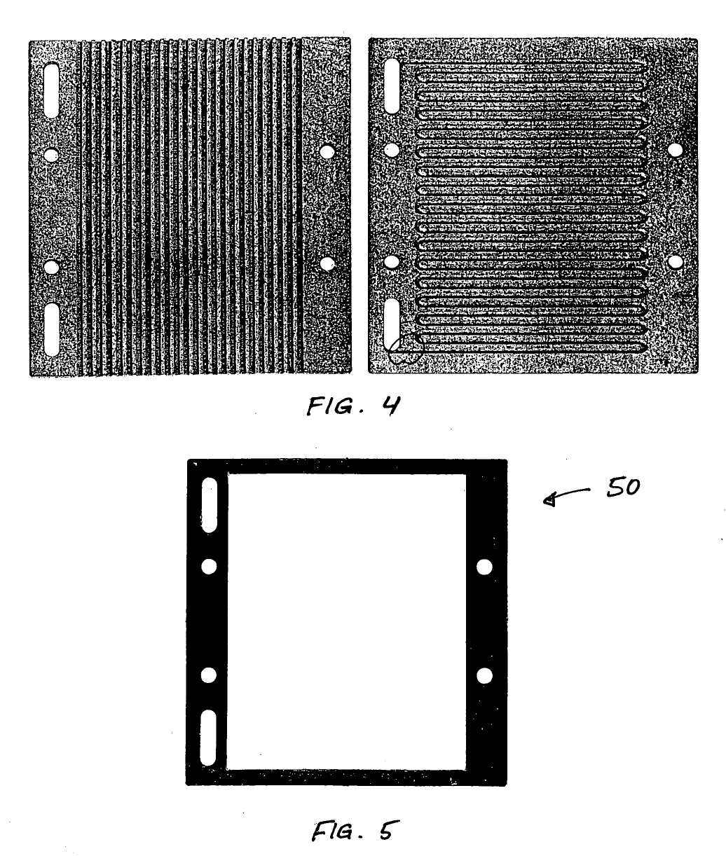

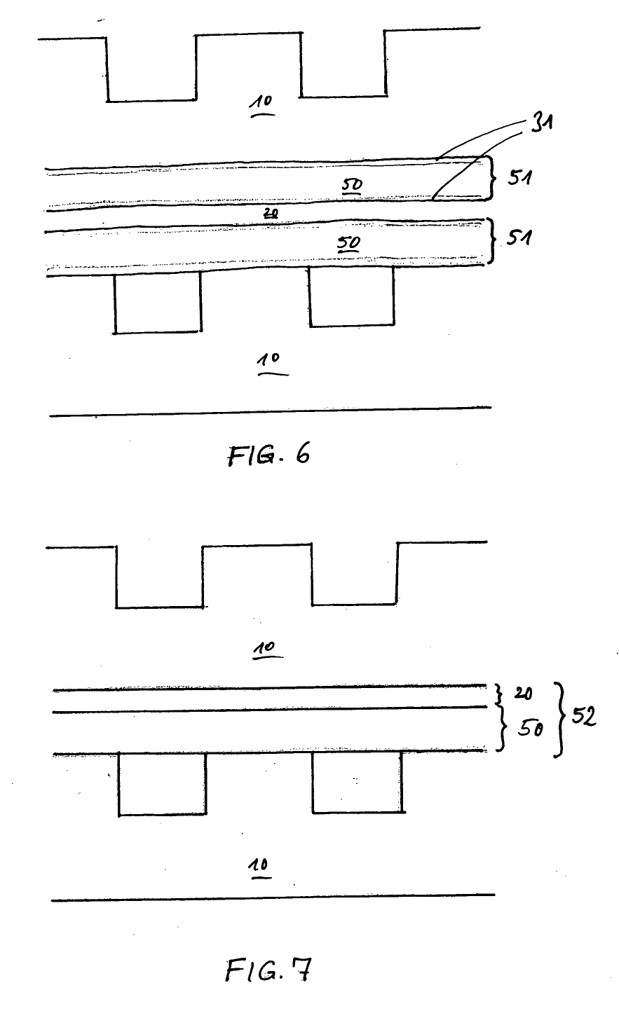

FIG. 4 shows the upper and the lower side of a flow plate constituted by a bipolar plate with the corresponding flow fields on the sides of the cathode and the anode;

FIG. 5 shows a sealing frame according to the invention for the type of bipolar plates shown in FIG. 4;

FIG. 6 shows the use of an embodiment according to the invention for avoiding the leakages shown in FIG. 3;

FIG. 7 shows the use of additional embodiments according to the inventioin for avoiding the leakages shown in FIG. 3.

FIG. 1 shows a schematic representation of an fuel cell stack 1 comprising an alternating stacking of bipolar plates 10 and planar or plate-shaped electrolytic facilities 20. The electrolytic facilities comprise catalysts, electrodes and gas diffusion layers, which are not illustrated in detail for obtaining a better idea.

The regions positioned between the bipolar plates 10 and the electrolytic facilities 20 are called cathode and anode regions or chambers. A substantial criterion for the design of fuel cell stacks always resides in the avoidance that cathode fluids can unintentionally get into an anode chamber and, vice versa, that anode fluids can unintentionally get into a cathode chamber. For this reason the fluids are frequently supplied/removed at different places of the stack. With the possible exception of lateral leadthroughs or cavities for the supply and removal of fluids, the cathode and anode chambers must laterally be sealed in a fluid-impermeable manner.

For illustrating this, FIG. 2 shows a perspective explosive representation of an enlarged section of the fuel cell stack. A surrounding seal 30 is provided between an electrolytic facility 20 and a bipolar plate 10, which—in the configuration as shown—entirely seals the lateral left and right contact surfaces between the electrolytic facility 20 and the bipolar plate 10. In the interior, the seal 30 spares a portion approximately corresponding, in view of the surface, to the electrodes 21 disposed on the upper side and the lower side of the electrolytic facility 20. The upper side of the outlined bipolar plate 10 has a plurality of continuous parallel cavities 11 serving the supply and the removal of a fluid on the side of the cathode (or the anode). Similar cavities are also provided on the lower side of the bipolar plate 10 (not shown in FIG. 2, compare FIG. 4 in this respect), where they serve the supply and the removal of a fluid on the side of the anode (or the cathode) correspondingly.

The lateral sealing of the (anode and cathode) “chambers”, i.e. the portions between the bipolar plate 10 and the electrolytic facility 20, constitutes a problem which is overcome in technical science only insufficiently or with a large amount of work involved. The causes for such leakages are manifold: different temperatures during the assembly and operation, ageing processes (becoming stronger by repeated heating and cooling), flowing etc. contribute to leakages to the same extent as do non-uniform gap widths between surfaces to be sealed.

FIG. 3 is a sectional view for illustrating a possible cause for leakages in stacks constructed in the conventional manner, i.e. without sealing frame.

The drawing shows a pair of bipolar plates 10 with a sandwich-like brought in electrolytic facility 20 which, in the present case, is formed by a thin and relatively easy to deform membrane. A seal 30 is provided between each bipolar plate 10 and the electrolytic facility 20.

The upper side of the illustrated bipolar plates 10 is provided with the channels 11 pushing through the side portions, which are bridged over by the adjacent seal 30. As a result there is the tendency that sealing material penetrates somewhat into the channels 11, which may entail several negative consequences:

Thus, on the one hand, the flow conditions in the channels 11 are changed as a result of the partially reduced cross-section. In the worst case, the channels may be blocked entirely (the drawing is not true to scale). On the other hand, the membrane 20 and the upper seal 30 connected to the flat lower side of the upper bipolar plate 10 as well as the lower seal 30 may give way, resulting in a leaky spot u towards the lower flow field of the upper bipolar plate 10. At these spots a fluid exchange between the anode and cathode chambers can occur, which negatively influences the operation of the fuel cell or makes it completely impossible.

In order to overcome these difficulties the invention provides for a sealing frame 50, which replaces the above-described seals or serves as a base or supporting material for these seals, thereby reducing the tendency thereof to temporal and/or local changes.

FIG. 5 shows such a sealing frame 50, which is formed to be used with the bipolar plate illustrated in the top and bottom view of FIG. 4.

One side of the bipolar plate shown in FIG. 4 comprises the continuous parallel longitudinal channels (partial picture on the left) already outlined in FIGS. 2 and 3. The supply and the removal of the fluid take place directly at the ends of these channels, i.e. on the front and rear side of the stack.

The other side of the bipolar plate only has one continuous, but meandering channel, whereof the longer partial sections are likewise substantially parallel to each other and perpendicular to the above-described channels. For the supply and removal of fluid two bores are provided in each bipolar plate, which communicate with the ends of the meandering channel and which have an oval shape in the embodiment currently described.

Moreover, the bipolar plates described in this embodiment comprise four additional circular bores which serve to assemble the fuel cell stack.

The sealing frames 50 provided for this type of a bipolar plate substantially have the same contour as the bipolar plate and are provided with recesses corresponding to the aforementioned bores through the bipolar plates. The sealing frame has a central recess (in the present case a rectangular one), the inner dimensions of which are dimensioned in correspondence with the surfaces of the electrodes. They moreover correspond to approximately the size of the flow field illustrated in the partial picture of FIG. 4 on the right.

The lateral portions of the bipolar plate surrounding the flow fields are plane, except for the discontinuances by the above-described bores and the channels pushing through the lateral portions (partial picture of FIG. 4 on the left). If the construction is a conventional one—without the inventive sealing frame 50—the problems discussed in connection with FIG. 3 may occur at these spots.

For assembling a fuel cell stack with the aid of the frame according to the invention a plurality of arrangements are possible, two of which are illustrated in FIGS. 6 and 7.

In comparison with FIG. 3, the seals 30 provided directly between the bipolar plate 10 and the electrolytic facility 20 in FIG. 6 are each replaced by a sealing frame/seal combination 51, which is formed of a sealing frame 50 coated with sealing material 31 on both sides. The sealing frame 50 can, for example, be made of metal so as to give the seals 31 provided on the same dimensional stability, which is an advantage for both the assembly of the stack (better handling ability, smaller sensitivity) and the assembled stack (impermeability, stability).

The application of a particularly advantageous embodiment of the sealing frame 50 according to the invention is illustrated in FIG. 7:

In this case, the frame is made of a material having sealing properties itself, so that no additional sealing materials have to be applied to the contact surface between the frame 50 and the lower bipolar plate 10. The electrolytic facility 20, which is formed of a membrane in the case currently described, which likewise has sealing properties, is joined on the upper side of the frame.

Thus, a separate seal is required neither for the contact surface between the frame 50 and the electrolytic facility 20 nor for the contact surface between the electrolytic facility 20 and the bipolar plate 10.

In the embodiment illustrated in FIG. 7 a particularly easy assembly of a fuel cell stack is made feasible by that the sealing frame 50 and the electrolytic membrane of the electrolytic facility 20 are prefabricated to form a combined unit 52.

Similar advantages may be achieved with other prefabricated combinations, e.g. by sealingly prefabricated bipolar plate/sealing frame combinations.

In all embodiments covered by the patent claims the sealing frame according to the invention contributes to ensure an easier and more reliable assembly of fuel cell stacks. As compared to conventional sealings, a better mutual sealing of the cathode and anode regions of a stack is achieved by the alternative or additional use of the sealing frame.

1. Sealing frame for fuel cell stacks having an alternating arrangement of flow plates and electrolytic facilities and cathode and anode regions formed between the flow plates and the electrolytic facilities, wherein
the sealing frame is formed such that it is suited for installation between the flow plates and ensures the mutual sealing of the cathode regions and the anode regions, with outer dimensions of the sealing frame being adapted to the contour of the flow plates and with the sealing frame substantially having the same outer dimensions as the flow plates, with inner dimensions of the sealing frame being adapted to the contour of an active region of the electrolytic facilities of the fuel cell stack and with the sealing frame having substantially the same inner dimensions as the active regions of the electrolytic facilities, and with the sealing frame having cut-outs for mounting devices and/or facilities for the supply and the removal of fluids.

2. Sealing frame according to claim 1, comprising a sealing material.

3. Sealing frame according to claim 2, formed of a sealing material.

4. Sealing frame according to claim 2, with a sealing material coating on one or both sides.

5. Sealing frame according to one of the preceding claim 1, with an electrolytic facility connected with the sealing frame in a fluid-impermeable manner.

6. Flow plate having a sealing frame according to claim 1 attached on one side of the flow plate in a sealing manner.

7. Flow plate having two sealing frames according to claim 1 attached on each side of the flow plate in a sealing manner.

8. Method of fabricating a fuel cell stack having an alternating arrangement of flow plates and electrolytic facilities, wherein, for bridging over channels which push through lateral portions of the flow plates, a sealing frame according to claim 1 is provided at least on the side of each flow plate on which the side portions are pushed through by the channels.

9. Sealing frame according to claim 3, with a sealing material coating on one or both sides.

10. Sealing frame according to claim 2, with an electrolytic facility connected with the sealing frame in a fluid-impermeable manner.

11. Sealing frame according to claim 3, with an electrolytic facility connected with the sealing frame in a fluid-impermeable manner.

12. Sealing frame according to claim 4, with an electrolytic facility connected with the sealing frame in a fluid-impermeable manner.

13. Flow plate having a sealing frame according to claim 2 attached on one side of the flow plate in a sealing manner.

14. Flow plate having a sealing frame according to claim 3 attached on one side of the flow plate in a sealing manner.

15. Flow plate having a sealing frame according to claim 4 attached on one side of the flow plate in a sealing manner.

16. Flow plate having a sealing frame according to claim 5 attached on one side of the flow plate in a sealing manner.

17. Flow plate having two sealing frames according to claim 2 attached on each side of the flow plate in a sealing manner.

18. Flow plate having two sealing frames according to claim 3 attached on each side of the flow plate in a sealing manner.

19. Flow plate having two sealing frames according to claim 4 attached on each side of the flow plate in a sealing manner.

20. Flow plate having two sealing frames according to claim 5 attached on each side of the flow plate in a sealing manner.
